(19) United States
(12) Patent Application Publication
(10) Pub. No.: US 2023/0367653 A1
(43) Pub. Date: Nov. 16, 2023

(54) SYSTEMS AND METHODS FOR GRID INTERACTIVE DATACENTERS

(71) Applicant: Microsoft Technology Licensing, LLC, Redmond, WA (US)

(72) Inventors: Alok Gautam KUMBHARE, Sammamish, WA (US); Ehsan NASR AZADANI, Sammamish, WA (US); Ricardo Gouvêa BIANCHINI, Bellevue, WA (US); Mark Alan MONROE, Louisville, CO (US); Christian L. BELADY, Mercer Island, WA (US); Osvaldo P. MORALES, Normandy Par, WA (US); Kyle WOOLCOCK, Redmond, WA (US); Rodrigo Lemos de ASSIS, Kirkland, WA (US); Brijesh WARRIER, Bellevue, WA (US); Marcus Felipe FONTOURA, Medina, WA (US); Ashish RANIWALA, Parkland, FL (US); Nithish MAHALINGAM, Sammamish, WA (US)

(21) Appl. No.: 17/741,203

(22) Filed: May 10, 2022

(51) Int. Cl. G06F 9/50; G06K 9/62; G06N 20/00

(52) U.S. Cl. CPC G06F 9/5083; G06F 9/5077; G06F 9/5033; G06K 9/6256; G06N 20/00

(57) ABSTRACT

A method of power management in a datacenter includes obtaining at least one workload status of at least one server rack, obtaining at least one infrastructure parameter, obtaining at least one utility telemetry, and comparing the at least one workload status to the at least one utility telemetry. The method further includes determining a workload demand based at least partially on a difference between the at least one workload status and the at least one utility telemetry and changing the at least one infrastructure parameter based on the workload demand and the at least one infrastructure parameter.

### BACKGROUND

### Background and Relevant Art

Datacenters consume a large amount of electricity. Changes in the properties and/or source of the electricity provided by a grid can adversely affect a datacenter through increased operating cost, ability to power computational resources, or increased carbon intensity.

### BRIEF SUMMARY

In some embodiments, a method of power management in a datacenter includes obtaining at least one workload status of at least one server rack, obtaining at least one infrastructure parameter, obtaining at least one utility telemetry, and comparing the at least one workload status to the at least one utility telemetry. The method further includes determining a workload demand based at least partially on a difference between the at least one workload status and the at least one utility telemetry and changing the at least one infrastructure parameter based on the workload demand and the at least one infrastructure parameter.

In some embodiments, a system for controlling power supply in a datacenter includes a control service, an energy controller in data communication with the control service, and a workload controller in data communication with the control service. The control service is configured to obtain at least one workload status of at least one server rack, obtain at least one infrastructure parameter, obtain at least one utility telemetry, and compare the at least one workload status to the at least one utility telemetry. The control service is further configured to determine a workload demand based at least partially on a difference between the at least one workload status and the at least one utility telemetry and change the at least one infrastructure parameter based on the workload demand and the at least one infrastructure parameter without exporting power to the utility grid.

In some embodiments, a method of power management in a datacenter includes obtaining at least one workload status of at least one server rack, obtaining at least one infrastructure parameter, obtaining at least one utility telemetry, and inputting the at least one utility telemetry, at least one workload status, and the at least one infrastructure parameter into an ML model. The method further includes changing the at least one infrastructure parameter based on the at least one utility telemetry, at least one workload status, and the at least one infrastructure parameter and changing the at least one workload status based on the at least one utility telemetry, at least one workload status, and the at least one infrastructure parameter.

This Summary is provided to introduce a selection of concepts in a simplified form that are further described below in the Detailed Description. This Summary is not intended to identify key features or essential features of the claimed subject matter.

Additional features and advantages will be set forth in the description which follows, and in part will be obvious from the description, or may be learned by the practice of the teachings herein. Features and advantages of the disclosure may be realized and obtained by means of the instruments and combinations particularly pointed out in the appended claims. Features of the present disclosure will become more fully apparent from the following description and appended claims or may be learned by the practice of the disclosure as set forth hereinafter.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example embodiments, the embodiments will be described and explained with additional specificity and detail through the use of the accompanying drawings in which:

FIG. 1 is a schematic representation of a datacenter, according to at least some embodiments of the present disclosure;

FIG. 2 is a flowchart illustrating a method of power management in a datacenter, according to at least some embodiments of the present disclosure;

FIG. 3 is a schematic representation of a machine learning model, according to at least some embodiments of the present disclosure;

FIG. 4 is a flowchart illustrating a method of training an ML model, according to at least some embodiments of the present disclosure; and

FIG. 5 is a flowchart illustrating another method of power management in a datacenter, according to at least some embodiments of the present disclosure.

### DETAILED DESCRIPTION

The present disclosure generally relates to systems and methods for power management in a datacenter. More particularly, systems and methods described herein are grid-aware and can adjust power supply and consumption in the datacenter at least partially in response to receive telemetry of the utility grid that provides electricity to the datacenter and/or co-location(s) therein.

In some embodiments, systems and methods according to the present disclosure allow a datacenter or co-location within a datacenter to provide computational services more efficiently and/or faster while reducing operating costs and/or carbon impact of the datacenter operation. In some embodiments, a control service or control plane of a datacenter communications with a substation providing power to a co-location of server computers in the datacenter and one or more controllers of the co-location to allow both the control service to change process allocation and power supplies to the co-location based on utility availability at the substation. In at least one embodiment, the control service can change virtual machine (VM) allocation within the co-location and change or adjust at least one power source of the co-location in response to telemetry received from the utility substation.

In some embodiments, a datacenter including one or more co-locations of server computers includes infrastructure resources configured to provide high availability (e.g., via power supply devices like uninterruptible power supplies (UPSes)) and software controllers that enable efficient utilization of the datacenter. For example, a software controller may efficiently use the compute and/or information technology (IT) resources in a datacenter through one or more of power capping, workload shedding, and proactive shifting, such as ahead of planned maintenance events. In some embodiments, redundant compute and/or IT resources are used only during planned maintenance or power outage scenarios, and the redundant resources may be unused during normal datacenter operation. Thus, the redundant compute and/or IT resources may provide opportunity for various grid-interactive services, such as frequency regulation, frequency containment, and demand response.

Such example scenarios may require different reaction times and durations and are limited by battery capacities and the need to maintain enough backup energy to support any datacenter failure events. In some embodiments, systems and methods of power management according to the present disclosure leverage a combination of energy storage for fast reaction over short durations and workload management for long-term regulation. A hybrid approach of on-site energy storage and/or generation combined with workload management (e.g., power capping, workload shifting, power-aware scheduling) may further reduce reliance on fossil fuel-based electricity.

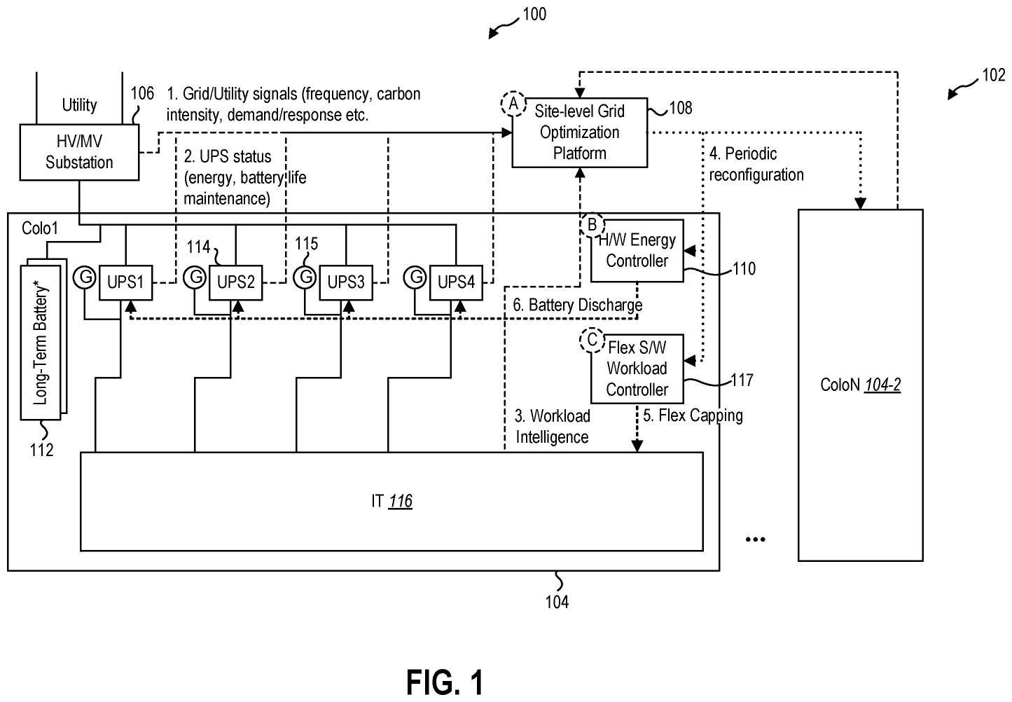

FIG. 1 is a system diagram illustrating an embodiment of a system 100 of power management. In some embodiments, a datacenter 102 site consists of one or more co-located datacenters (“co-locations” 104-1), deriving power from the same high voltage utility substation 106. In some embodiments, utility high voltage lines from the utility grid feed into the substation 106, which in turn feeds multiple rooms (co-locations 104-1) in one or more datacenters 102 through a set of medium voltage transformers. In at least one embodiment, an external utility grid (e.g., an electricity utility company) supplies power to multiple co-locations 104-1, and each co-location may have its own transformer, UPS battery backup, generator, fuel cell(s), and combinations thereof. One or more co-locations 104-1 may participate in grid services and some embodiments of control systems and methods described herein may coordinate available energy storage and workload characteristics across these co-locations 104-1.

In some embodiments, a system 100 for power management in a datacenter 102 includes at least a control service 108 that obtains or accesses a plurality of properties and/or telemetries of the utility (such as at the substation 106) and datacenter 102 to provide instructions to one or more components of the datacenter 102. The instructions provided by the control service 108 allows the datacenter 102 to make computational services available more efficiently to users of the datacenter 102. The control service 108 may be remote to the datacenter and/or the co-location(s) and obtain information about and communicate with components of the datacenter 102 via a network connection. In some embodiments, it may be beneficial for the control service 108 to have response times to changing conditions of less than 5 milliseconds (ms), less than 2 ms, or less than 1 ms, and it may be beneficial to have the control service 108 located on-site of the datacenter 102 to facilitate faster communication times. In some embodiments, the control service 108 is a service operating on a control computing device in the datacenter in communication with other components of the datacenter 102. In some embodiments, the control service 108 includes a dedicated processor, hardware storage device, and/or computing device that executes the control service 108.

In some embodiments, the control service 108 is in data communication with an energy controller 110 of the co-location 104-1. For example, each co-location within the datacenter may have an energy controller that controls, allocates, manages, and combinations thereof power supply infrastructure of the co-locations. In some examples, the energy controller 110 is at least partially responsible for enacting charge and/or discharge of long-term energy storage 112 for the co-location. In some examples, the energy controller is at least partially responsible and other hardware power supply and/or power storage operations. It should be understood that while FIG. 1 describes batteries, other long-term energy storage 112 or supply may be used, such as hydrogen fuel cells, gravity storage, or other long-term stable energy sources.

For example, the energy controller 110 may be in data communication with one or more UPSs 114 of the co-location 104-1. In some embodiments, a co-location has at least one UPS 114 for each server rack 116 of the co-location. In some embodiments, a co-location has a UPS 114 for each server rack 116 of the co-location 104-1. In some embodiments, a co-location has at least one UPS 114 configured to provide power to a server rack 116 of the co-location 104-1. In some embodiments, at least one UPS 114 is configured to provide power to a plurality of server racks 116 of the co-location 104-1. The energy controller may communicate with a UPS 114 to provide power or additional power to one or more server computers or other IT components in response to changes in the utility power supply of the co-location 104-1 and/or datacenter 102.

In another example, the energy controller 110 may be in data communication with one or more generators 115 of the co-location. In some embodiments, a co-location has at least one generator 115 for each server rack 116 of the co-location 104-1. In some embodiments, a co-location has a generator 115 for each server rack 116 of the co-location 104-1. In some embodiments, a co-location 104-1 has at least one generator 115 configured to provide power to a server rack 116 of the co-location 104-1. In some embodiments, at least one generator 115 is configured to provide power to a plurality of server racks 116 of the co-location 104-1. The energy controller 110 may communicate with a generator 115 to provide power or additional power to one or more server computers or other IT components in response to changes in the utility power supply of the co-location 104-1 and/or datacenter 102.

In another example, the energy controller 110 may be in data communication with one or more long-term energy storages 112, such as a long-term battery, of the co-location 104-1. In some embodiments, a co-location 104-1 has at least one long-term energy storage 112 for each server rack 116 of the co-location 104-1. In some embodiments, a co-location 104-1 has a long-term energy storage 112 for each server rack 116 of the co-location 104-1. In some embodiments, a co-location 104-1 has at least one long-term energy storage 112 configured to provide power to a server rack 116 of the co-location 104-1. In some embodiments, at least one long-term energy storage 112 is configured to provide power to a plurality of server racks 116 of the co-location 104-1. The energy controller may communicate with a long-term energy storage 112 to provide power or additional power to one or more server computers or other IT components in response to changes in the utility power supply of the co-location 104-1 and/or datacenter 102.

In some embodiments, the control service 108 is in data communication with a workload controller 117. The workload controller 117 is responsible for enacting workload operations and/or controls such as power capping, shutting down servers, VM allocation, process allocation, and workload migration. In some embodiments, the workload controller 117 responds to long-term (minutes to hours) grid service requests through a combination of power capping, shutting down servers, VM allocation, process allocation, and workload migration. In some embodiments, the workload controller 117 engages one or more of power capping, shutting down servers, VM allocation, process allocation, and workload migration based at least partially on the hardware capability (e.g., able to be power-capped/throttled or not), availability requirements (e.g., software redundant or not), utilization patterns, and potential impact of the one or more of power capping, shutting down servers, VM allocation, process allocation, and workload migration on the workloads and/or processes.

The determination and/or instructions to engage one or more of power capping, shutting down servers, VM allocation, process allocation, and workload migration is made, in some embodiments, at the control service 108. In some embodiments, the workload controller 117 provides to the control service 108 a list of viable options for workload management (e.g., which of the power capping, shutting down servers, VM allocation, process allocation, and workload migration are available options based at least partially on hardware capability, availability requirements, and current workload/processes). In some embodiments, the control service 108 determines which options to engage based at least partially on obtained information, such as utility telemetry and infrastructure status. In some examples, the obtained information includes the amount of power that needs to be “recovered”, the latency requirements (e.g., few seconds for an unplanned event; advance notice for a planned event), and the dynamic impact functions defined by the workloads. In some embodiments, the parameters are obtained and/or calculated by the control service 108 periodically and/or on demand and provided to the workload controller 117, which determines the workload management decisions.

In some embodiments, the workload controller 117 monitors critical events (e.g., grid service requests or datacenter equipment status) and takes the corresponding actions when any critical events are detected. In such embodiments, the workload controller 117 is tasked with responding to potentially critical events (e.g., not enough battery backup), which can reduce response time to specific critical events.

The control service 108 then uses these inputs and a set of heuristics or machine learning (ML) to decide whether to use hardware-based energy management to compensate for power demands of the datacenter and/or co-locations, such as discharging long-term energy storage 112 or starting a generator 115 via the energy controller 110, and/or use the workload controller 117 to lower power consumption of the datacenter and/or co-locations through software-defined mechanisms.

In some embodiments, the control service 108 is further in communication with a second co-location 104-2 (or more) that includes a second energy controller and a second workload controller to manage the infrastructure power sources and workload, respectively, of the second co-location. The control service can coordinate the workload controllers to migrate workload or processes between the co-locations 104-1, 104-2 or coordinate the energy controllers to distribute power from infrastructure power sources between the co-locations 104-1, 104-2.

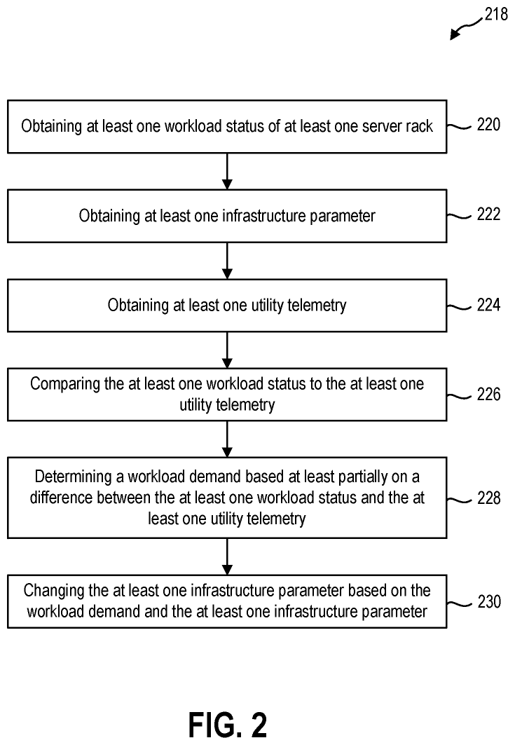

FIG. 2 is a flowchart illustrating an embodiment of a method 218 of power management. In some embodiments, the method includes, at the control service, obtaining at least one workload status of at least one server rack at 220, obtaining at least one infrastructure parameter at 222, and obtaining at least one utility telemetry and 224. In some embodiments, the control service obtains at least a portion of the workload status from the workload controller. In some embodiments, the control service obtains at least a portion of the workload status from one or more server computers. In some embodiments, the controller service obtains at least a portion of the workload status from a rack manager of a server rack in the co-location. For example, a rack manager may be in communication with one or more server computers in the server rack, and the rack manager may monitor power draw of the server computer(s). The power draw is the amount of electrical power (from all sources internal or external to the datacenter) that the server computer(s) require to perform the current or requested workload. For example, the power draw of a single server computer may be monitored, a power draw of a rack of server computers may be monitored, or a power draw of a co-location of server computers may be monitored.

In some embodiments, the workload status includes one or more of VM allocation, process allocation, a process priority list, process migration status, utilization patterns, workload performance and availability requirements, failover capabilities, or other information related to the computational operations of the server computers in the co-location. For example, the VM allocation information can inform the workload controller and/or the control service of the quantity of VMs allocated to a particular server computer, server rack, or co-location. The quantity of VMs can inform the workload controller and/or the control service of computational capacity available on the allocated servers and/or the maximum power draw that could potentially be required of the allocated servers. The workload controller and/or the control service can use the VM allocation information to help anticipate computational and power demands of the co-location and/or datacenter.

In some examples, the process allocation information can inform the workload controller and/or the control service of the particular processes requested or currently being performed on at least some of the server computers of the server rack, co-location, and/or datacenter. In some embodiments, the workload controller and/or the control service includes a process inventory to monitor the processes, as well as the power consumption and computational demands thereof. For example, the workload controller and/or the control service may determine that a first process allocated to a first server computer within the co-location has a first power consumption associated with the first process, and the workload controller and/or the control service may determine that a second process allocated to a second server computer within the co-location has a second power consumption associated with the second process. The workload controller and/or the control service may determine a total current or expected power consumption of the allocated processes based at least partially on the process inventory.

In some embodiments, the process allocation and/or process inventory has a process priority list that informs the workload controller and/or the control service of the relative importance of the processes currently executed or queued in the co-location. For example, a first process allocated to a first server computer may have a higher priority than a second process allocated to a second server computer, and the workload controller may power cap or throttle the second server computer to prioritize the performance of the first process of the first server computer.

In some examples, the process migration status can inform the workload controller and/or the control service of the availability of computational resources for migration of a process between server computers and/or between co-locations. In some examples, the process migration status can inform the workload controller and/or the control service of the initiation and/or completion of a process migration to allow the workload controller and/or the control service to track availability of computational resources.

In some embodiments, the utilization patterns can inform the workload controller and/or the control service of the current or predicted future state of the workload on the co-location based at least partially on historical data and trends of resource utilization. For example, the utilization pattern may include process allocation, power draw, and/or computational load that is based at least partially on time of day, day of the week, day of the year, or correlation to other events, such as weather, holidays, or periodic events. In some embodiments, the workload controller and/or the control service may determine a trend or predicted future state of the workload based on the utilization patterns and pre-emptively change or adjust workload or power supply to at least partially compensate for the trend or predicted future state of the workload.

In some embodiments, the control service and/or energy controller obtains infrastructure parameters. For example, the energy controller may obtain or store the infrastructure parameters and the control service may obtain the infrastructure parameters from the energy controller. The infrastructure parameters include information related to the performance, history, or requirements of the hardware of the co-location, and/or datacenter. In some embodiments, the infrastructure parameters may include battery/UPS state of charge, battery/UPS degradation (e.g., degradation counters), generator capacity, component temperatures, server computer power draws, maintenance schedule, and other measurements or properties of the energy source(s) and sink(s) within the co-location and/or datacenter.

In some embodiments, the battery state of charge or UPS state of charge includes a percentage state of charge of a long-term battery and/or a UPS, a nominal voltage of a long-term battery and/or a UPS, or a nominal state of charge (e.g., a kilowatt-hour measurement) of a long-term battery and/or a UPS. The battery state of charge or UPS state of charge may inform the control service and/or energy controller of the duration of time that the battery/UPS may provide power or additional power to the server computers in the event of a utility failure or other event.

In some embodiments, the generator capacity allows the control service and/or energy controller to know how much peak power a generator can provide, how long the generator can provide the power, and the total power the generator can provide. In some embodiments, the infrastructure parameter further includes a startup time for the generator, which may inform the control service and/or energy controller of a delay in starting the generator before the generator can begin providing power to the co-location and/or datacenter.

In some embodiments, the battery/UPS degradation includes a total battery aging parameter of the battery and/or UPS, quantity of charge/discharges cycles of the battery and/or UPS, or depth of charge available. For example, a battery may have a limited quantity of charge cycles based on the depth of charge/discharge. A cost is associated with each discharge and charge cycle of the battery. In some embodiments, the age of the battery affects the capacity of the battery, limiting the amount of power an older battery can provide to the co-location relative to a newer battery. In some embodiments, the energy controller monitors the age of the battery (in time, cycles, or capacity) and provides the age to the control service. In some embodiments, the control service monitors the age of the battery based at least partially on information provided by the energy controller.

The energy controller and/or control service, in some embodiments, monitors component temperatures, as elevated temperatures can affect the efficient and/or operational lifetime of the batteries, UPS, or generators in data communication with the energy controller and/or control service.

In some embodiments, the infrastructure parameters include a maintenance schedule of one or more components of the co-location and/or datacenter. For example, some components may be unavailable due to planned maintenance. In other examples, a planned maintenance may require additional power provided by a fuel cell, a battery, other long-term energy storage, UPS, or generator, and the energy controller and/or control service may prepare the fuel cell, a battery, other long-term energy storage, UPS, or generator in advance to provide the required capacity for the additional power.

The control service obtains utility telemetry, in some embodiments, from a substation, a utility line, or other communication with the utility grid. Utility telemetry may include frequency of the power provided by the utility to and/or through the substation, a carbon intensity of the power provided by the utility to and/or through the substation, and power demand and response of the utility grid. The frequency of the power provided by the utility may vary with grid stability, supply, and demand. In the electric utility grid, operators attempt to maintain grid balance and reliability and keep its frequency within defined limits. Deviation from the nominal frequency, i.e., 50 Hz or 60 Hz, results from a mismatch between supply and demand (a phenomenon that becomes exacerbated by a greater penetration of variable renewable energy sources, which are also associated with carbon intensity of the provided power). A control service according to the present disclosure, in some embodiments, can help operators regulate the grid frequency by lowering or increasing a power draw of the co-location and/or datacenter. Frequency regulation may require fast-response energy storage, generators, or fast workload management.

Additionally, some embodiments of a control service according to the present disclosure can provide or assist in providing frequency containment. In some examples, frequency containment reserves, such as those provided by the long-term energy storage, UPS, or generator in communication with the energy controller, can provide a primary response to sudden frequency variations, typically low frequency, caused by a contingency event in the utility grid or sudden drop of renewable energy sources. As the system inertia reduces in the areas with high penetration of renewable energy, even faster reacting reserves (such as batteries relative to generators) may be used to at least partially compensate for low inertia situations. In some embodiments, fast-response battery energy storage in datacenters with limited energy storage duration can provide frequency containment in response to the obtained utility telemetry.

In some embodiments, the obtained utility telemetry includes carbon intensity related to the source and deliver of the power provide by the utility grid. In some embodiments, the control service selectively charges or discharges a battery or engages a generator based on the reducing carbon impact of the co-location and/or datacenter.

In some embodiments, the method of FIG. 2 further includes comparing the at least one workload status to the at least one utility telemetry at 226 and determining a workload demand based at least partially on a difference between the at least one workload status and the at least one utility telemetry at 228. Comparing the at least one workload status and the at least one utility telemetry allows the control service to determine a difference between the power provided by the utility grid and the power required by the current or predicted future state of the workload. For example, a workload status and utility telemetry may indicate a positive workload demand that requires the deployment of one or more of the infrastructure power sources, such as the long-term battery, UPS, or generator, to at least partially compensate for the positive workload demand. In some embodiments, a workload status and utility telemetry may indicate a negative workload demand that provides an opportunity to charge the long-term battery or to overclock processing resources in the co-location and/or datacenter.

In some embodiments, the method further includes changing the at least one infrastructure parameter based at least partially on the workload demand and the at least one infrastructure parameter at 230. For example, changing the at least one infrastructure parameter may include discharging a long-term battery. In some examples, changing the at least one infrastructure parameter may include charging a long-term battery. In some examples, changing the at least one infrastructure parameter may include discharging a UPS. In some examples, changing the at least one infrastructure parameter may include engaging a generator. In some embodiments, changing the at least one infrastructure parameter supplements the power received from the utility grid based on the workload demand. In some embodiments, changing the at least one infrastructure parameter supplements the power received from the utility grid based on the workload demand without exporting power from the datacenter (i.e., from the long-term energy storage and/or generation) to the utility grid.

The workload status, the infrastructure parameter, and the utility telemetries may be inputs to an ML model to determine the outputs provided to the controllers by the control service. In other embodiments, the workload status, the infrastructure parameter, and the utility telemetries may be inputs into one or more of heuristics, mathematical models, and algorithms to determine the outputs provided to the controllers by the control service.

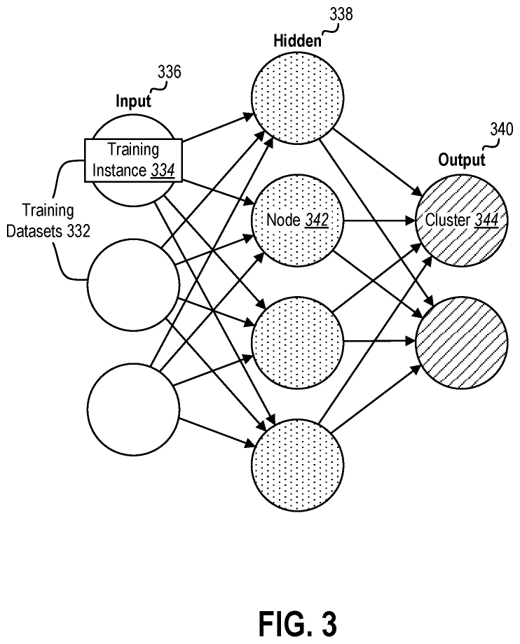

FIG. 3 is a schematic representation of a machine learning (ML) model that may be used with one or more embodiments of system and methods described herein. As used herein, a “machine learning model” refers to a computer algorithm or model (e.g., a classification model, a regression model, a language model, an object detection model) that can be tuned (e.g., trained) based on training input to approximate unknown functions. For example, a machine learning model may refer to a neural network or other machine learning algorithm or architecture that learns and approximates complex functions and generate outputs based on a plurality of inputs provided to the machine learning model. In some embodiments, a machine learning system, model, or neural network described herein is an artificial neural network. In some embodiments, a machine learning system, model, or neural network described herein is a convolutional neural network. In some embodiments, a machine learning system, model, or neural network described herein is a recurrent neural network. In at least one embodiment, a machine learning system, model, or neural network described herein is a Bayes classifier. As used herein, a “machine learning system” may refer to one or multiple machine learning models that cooperatively generate one or more outputs based on corresponding inputs. For example, a machine learning system may refer to any system architecture having multiple discrete machine learning components that consider different kinds of information or inputs.

As used herein, an “instance” refers to an input object that may be provided as an input to a machine learning system to use in generating an output, such as utility telemetry, workload status, and infrastructure parameters. For example, an instance may refer to any event in which the utility telemetry changes in a manner that affects the frequency of the provided power from the utility grid. For example, low-frequency event may be related to afternoon or evening, in regions with warmer weather, corresponding to an increased demand in the utility grid. In some embodiments, a low-frequency event may be at least partially compensated for with power capping or workload migration, while in other instances, a low-frequency event when workload is high or process priority is high may be at least partially compensated for with additional infrastructure power sources.

In some embodiments, the machine learning system has a plurality of layers with an input layer 336 configured to receive at least one input training dataset 332 or input training instance 334 and an output layer 340, with a plurality of additional or hidden layers 338 therebetween. The training datasets can be input into the machine learning system to train the machine learning system and identify individual and combinations of labels or attributes of the training instances that allow the co-location and/or datacenter to participate in grid services. In some embodiments, the inputs include utility telemetry, workload status, infrastructure parameters, or combinations thereof.

In some embodiments, the machine learning system can receive multiple training datasets concurrently and learn from the different training datasets simultaneously. For example, a training dataset of utility grid utility telemetry changes includes different information and/or labels than a training dataset including changes in workload status.

In some embodiments, the machine learning system includes a plurality of machine learning models that operate together. Each of the machine learning models has a plurality of hidden layers between the input layer and the output layer. The hidden layers have a plurality of input nodes (e.g., nodes 342), where each of the nodes operates on the received inputs from the previous layer. In a specific example, a first hidden layer has a plurality of nodes and each of the nodes performs an operation on each instance from the input layer. Each node of the first hidden layer provides a new input into each node of the second hidden layer, which, in turn, performs a new operation on each of those inputs. The nodes of the second hidden layer then passes outputs, such as identified clusters 344, to the output layer.

In some embodiments, each of the nodes 342 has a linear function and an activation function. The linear function may attempt to optimize or approximate a solution with a line of best fit, such as reduced power cost or reduced carbon intensity. The activation function operates as a test to check the validity of the linear function. In some embodiments, the activation function produces a binary output that determines whether the output of the linear function is passed to the next layer of the machine learning model. In this way, the machine learning system can limit and/or prevent the propagation of poor fits to the data and/or non-convergent solutions.

The machine learning model includes an input layer that receives at least one training dataset. In some embodiments, at least one machine learning model uses supervised training. Supervised training allows the input of a plurality of utility grid or workload events with known responses from the energy controller and/or workload controller and allows the machine learning system of the control service to develop correlations between the inputs and the responses to learn risk factors and combinations thereof. In some embodiments, at least one machine learning model uses unsupervised training. Unsupervised training can be used to draw inferences and find patterns or associations from the training dataset(s) without known incidents. In some embodiments, unsupervised learning can identify clusters of similar labels or characteristics for a variety of training instances and allow the machine learning system to extrapolate the safety and/or risk factors of instances with similar characteristics.

In some embodiments, semi-supervised learning can combine benefits from supervised learning and unsupervised learning. As described herein, the machine learning system can identify associated labels or characteristic between instances, which may allow a training dataset with known incidents and a second training dataset including more general input information to be fused. Unsupervised training can allow the machine learning system to cluster the instances from the second training dataset without known incidents and associate the clusters with known incidents from the first training dataset.

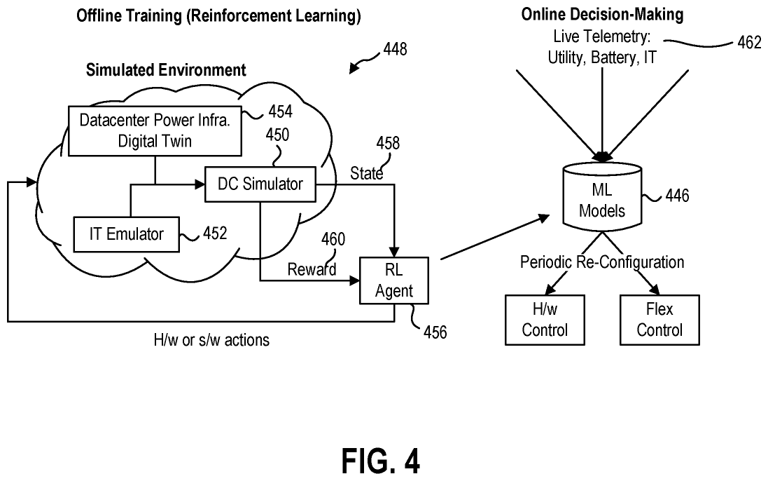

FIG. 4 is a flowchart illustrating an embodiment of a method of training an ML model 446, such as that described in relation to FIG. 3. In some embodiments, offline training of the ML model 446 may include an offline simulated environment (e.g., simulated environment 448) with a datacenter simulator 450 that receives inputs from an IT emulator 452 and a simulated datacenter power infrastructure 454. The simulated environment 448 outputs a state 458 to a reinforcement learning (RL) agent 456 with a reward 460 (positive or negative reward) associated with the state 458 of the datacenter simulator 450. The RL agent 456 can create a recurrent loop that provides further inputs the simulated environment 448 to refine the responses and/or outputs of the simulated environment 448 over time.

In some embodiments, the RL agent 456 provides information to an online ML model 446 that receives live inputs 462 including utility telemetry, workload status, and infrastructure parameters. The RL agent 456 and simulated environment 448 may allow the ML model 446 to be pretrained and/or continually trained offline with additional scenarios, which are then fused with the live inputs 462 at the ML model 446. A simulated environment 448 can allow for more rapid training of the ML model 446 without the datacenter and/or co-location experiencing the adverse utility grid or infrastructure conditions simulated in the simulated environment 448.

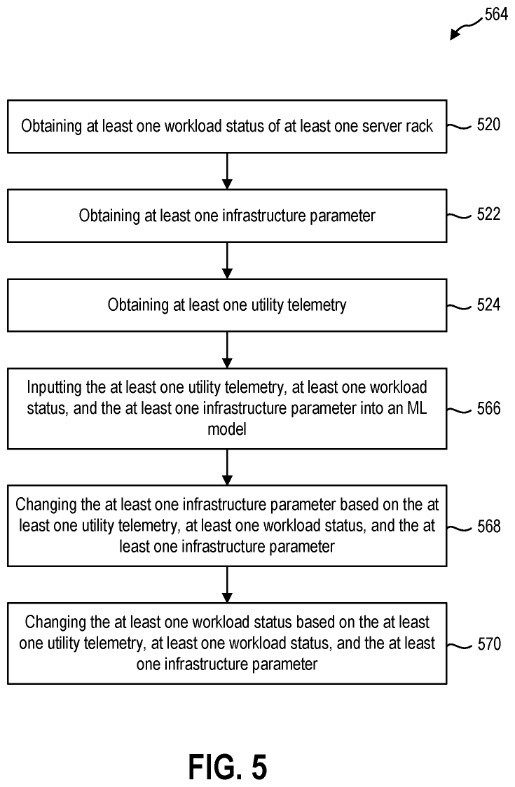

FIG. 5 is a flowchart illustrating another embodiment of a method 564 of power management. In some embodiments, a method of power management in a datacenter includes making changes to both the workload of a co-location and to the power infrastructure of the co-location. The control service may communicate with the energy controller and the workload controller to provide both short-term (e.g., fast response) and long-term grid services and workload balancing. For example, the control service may communicate with the infrastructure power sources (e.g., fuel cell, battery, UPS, generator) to provide rapid responses to a change in utility telemetry or workload status, while the control service also communicates with the workload controller to migrate workload to a second co-location and/or power cap the first co-location to balance the workload demand between available power and cost or carbon intensity of the available power.

In some embodiments, the method includes, at the control service, obtaining at least one workload status of at least one server rack at 520, obtaining at least one infrastructure parameter at 522, and obtaining at least one utility telemetry at 524. In some embodiments, the control service obtains at least a portion of the workload status from the workload controller. In some embodiments, the control service obtains at least a portion of the workload status from one or more server computers. In some embodiments, the controller service obtains at least a portion of the workload status from a rack manager of a server rack in the co-location.

The method further includes, in some embodiments, inputting the at least one utility telemetry, the at least one infrastructure parameter, and the at least one workload status into an ML model at 566, such as described herein, to determine at least one change to each of the at least one infrastructure parameter and the at least one workload status. Based on the output of the ML model, which may be pretrained as described in relation to FIG. 4, the method includes changing the at least one infrastructure parameter at 568 and the at least one workload status at 570.

In some examples, the control service may change at least one infrastructure parameter at 568 to charge an infrastructure power source from the utility grid based at least partially on a utility telemetry obtained at 524. In some embodiments, the control service may change at least infrastructure parameter at 568 to charge an infrastructure power source from the utility grid based at least partially on a workload status obtained at 520.

For example, a positive workload demand may arise from an infrastructure failure or partial infrastructure failure. In some embodiments, the control service and/or a workload controller may adjust the workload and/or processes of the server computers based on a change in infrastructure parameters. In at least one example, the change in infrastructure parameters may be related to a limited availability of infrastructure power to supply to the server computers. In such an example, the control service and/or workload controller may migrate workload to another co-location to reduce the workload demand. In some examples, the control service and/or workload controller may power cap or throttle the server computers to reduce the workload demand.

### INDUSTRIAL APPLICABILITY

In some embodiments, systems and methods according to the present disclosure allow a datacenter or co-location within a datacenter to provide computational services more efficiently and/or faster while reducing operating costs and/or carbon impact of the datacenter operation. In some embodiments, a control service or control plane of a datacenter communications with a substation providing power to a co-location of server computers in the datacenter and one or more controllers of the co-location to allow both the control service to change process allocation and power supplies to the co-location based on utility availability at the substation. In at least one embodiment, the control service can change virtual machine (VM) allocation within the co-location and change or adjust at least one power source of the co-location in response to telemetry received from the utility substation.

In some embodiments, a datacenter including one or more co-locations of server computers includes infrastructure resources configured to provide high availability (e.g., via power supply devices like uninterruptible power supplies (UPSes)) and software controllers that enable efficient utilization of the datacenter. For example, a software controller may efficiently use the compute and/or information technology (IT) resources in a datacenter through one or more of power capping, workload shedding, and proactive shifting, such as ahead of planned maintenance events. In some embodiments, redundant compute and/or IT resources are used only during planned maintenance or power outage scenarios, and the redundant resources may be unused during normal datacenter operation. Thus, the redundant compute and/or IT resources may provide opportunity for various grid-interactive services, such as frequency regulation, frequency containment, and demand response.

Such example scenarios may require different reaction times and durations and are limited by battery capacities and the need to maintain enough backup energy to support any datacenter failure events. In some embodiments, systems and methods of power management according to the present disclosure leverage a combination of energy storage for fast reaction over short durations and workload management for long-term regulation. A hybrid approach of on-site power sources combined with workload management (e.g., power capping, workload shifting, power-aware scheduling) may further reduce reliance on fossil fuel-based electricity.

In some embodiments, a datacenter site consists of one or more co-located datacenters, driving power from the same high voltage utility substation. In some embodiments, utility high voltage lines feed into the substation, which in turn feeds multiple rooms (co-locations) in one or more datacenters through a set of medium voltage transformers. In at least one embodiment, an external utility (e.g., an electricity utility company) supplies power to multiple co-locations, and each co-location may have its own transformer, UPS battery backup, generator, and combinations thereof. One or more co-locations may participate in grid services and some embodiments of control systems and methods described herein may coordinate available battery backup and workload characteristics across these co-locations.

In some embodiments, a system for power management in a datacenter includes at least a control service that obtains or accesses a plurality of properties of the utility and datacenter to provide instructions to one or more components of the datacenter. The instructions provided by the control service allows the datacenter to make computational services available more efficiently to users of the datacenter. The control service may be remote to the datacenter and/or the co-location(s) and obtain information about and communicate with components of the datacenter via a network connection. In some embodiments, it may be beneficial for the control service to have response times to changing conditions of less than 5 milliseconds (ms), less than 2 ms, or less than 1 ms, and it may be beneficial to have the control service located on-site of the datacenter to facilitate faster communication times. In some embodiments, the control service is a service operating on a control computing device in the datacenter in communication with other components of the datacenter. In some embodiments, the control service includes a dedicated processor, hardware storage device, and/or computing device that executes the control service.

In some embodiments, the control service is in data communication with an energy controller of the co-location. For example, each co-location within the datacenter may have an energy controller that controls, allocates, manages, and combinations thereof power supply infrastructure of the co-locations. In some examples, the energy controller is at least partially responsible for enacting charge and/or discharge of batteries for the co-location. In some examples, the energy controller is at least partially responsible and other hardware power supply and/or power storage operations.

For example, the energy controller may be in data communication with one or more UPSs of the co-location. In some embodiments, a co-location has at least one UPS for each server rack of the co-location. In some embodiments, a co-location has a UPS for each server rack of the co-location. In some embodiments, a co-location has at least one UPS configured to provide power to a server rack of the co-location. In some embodiments, at least one UPS is configured to provide power to a plurality of server racks of the co-location. The energy controller may communicate with a UPS to provide power or additional power to one or more server computers or other IT components in response to changes in the utility power supply of the co-location and/or datacenter.

In another example, the energy controller may be in data communication with one or more generators of the co-location. In some embodiments, a co-location has at least one generator for each server rack of the co-location. In some embodiments, a co-location has a generator for each server rack of the co-location. In some embodiments, a co-location has at least one generator configured to provide power to a server rack of the co-location. In some embodiments, at least one generator is configured to provide power to a plurality of server racks of the co-location. The energy controller may communicate with a generator to provide power or additional power to one or more server computers or other IT components in response to changes in the utility power supply of the co-location and/or datacenter.

In another example, the energy controller may be in data communication with one or more long-term energy storage, such as a fuel cell or long-term battery, of the co-location. In some embodiments, a co-location has at least one long-term energy storage for each server rack of the co-location. In some embodiments, a co-location has a long-term energy storage for each server rack of the co-location. In some embodiments, a co-location has at least one long-term energy storage configured to provide power to a server rack of the co-location. In some embodiments, at least one long-term energy storage is configured to provide power to a plurality of server racks of the co-location. The energy controller may communicate with a long-term energy storage to provide power or additional power to one or more server computers or other IT components in response to changes in the utility power supply of the co-location and/or datacenter.

In some embodiments, the control service is in data communication with a workload controller. The workload controller is responsible for enacting workload operations and/or controls such as power capping, shutting down servers, VM allocation, process allocation, and workload migration. In some embodiments, the workload controller responds to long-term (minutes to hours) grid service requests through a combination of power capping, shutting down servers, VM allocation, process allocation, and workload migration. In some embodiments, the workload controller engages one or more of power capping, shutting down servers, VM allocation, process allocation, and workload migration based at least partially on the hardware capability (e.g., able to be power-capped/throttled or not), availability requirements (e.g., software redundant or not), utilization patterns, and potential impact of the one or more of power capping, shutting down servers, VM allocation, process allocation, and workload migration on the workloads and/or processes.

The determination and/or instructions to engage the one or more of power capping, shutting down servers, VM allocation, process allocation, and workload migration is made, in some embodiments, at the control service. In some embodiments, the workload controller provides to the control service a list of viable options for workload management (e.g., which of the power capping, shutting down servers, VM allocation, process allocation, and workload migration are available options based at least partially on hardware capability, availability requirements, and current workload/processes). In some embodiments, the control service determines which options to engage based at least partially on obtained information, such as utility telemetry and infrastructure status. In some examples, the obtained information includes the amount of power that needs to be “recovered”, the latency requirements (e.g., few seconds for an unplanned event; advance notice for a planned event), and the dynamic impact functions defined by the workloads. In some embodiments, the parameters are obtained and/or calculated by the control service periodically and/or on demand and provided to the workload controller, which determines the workload management decisions.

In some embodiments, the workload controller monitors critical events (e.g., grid service requests or datacenter equipment status) and takes the corresponding actions when any critical events are detected. In such embodiments, the workload controller is tasked with responding to potentially critical events (e.g., not enough battery backup), which can reduce response time to specific critical events.

The platform then uses these inputs and a set of heuristics or machine learning (ML) to decide whether to use hardware-based energy management, such as discharging long-term energy storage or starting a generator via the energy controller and/or use the workload controller to lower power consumption through software-defined mechanisms.

In some embodiments, a method of power management includes, at the control service, obtaining at least one workload status of at least one server rack, obtaining at least one infrastructure parameter, and obtaining at least one utility telemetry. In some embodiments, the control service obtains at least a portion of the workload status from the workload controller. In some embodiments, the control service obtains at least a portion of the workload status from one or more server computers. In some embodiments, the controller service obtains at least a portion of the workload status from a rack manager of a server rack in the co-location. For example, a rack manager may be in communication with one or more server computers in the server rack, and the rack manager may monitor power draw of the server computer(s). The power draw is the amount of electrical power (from all sources internal or external to the datacenter) that the server computer(s) require to perform the current or requested workload. For example, the power draw of a single server computer may be monitored, a power draw of a rack of server computers may be monitored, or a power draw of a co-location of server computers may be monitored.

In some embodiments, the workload status includes one or more of VM allocation, process allocation, a process priority list, process migration status, utilization patterns, workload performance and availability requirements, failover capabilities, or other information related to the computational operations of the server computers in the co-location. For example, the VM allocation information can inform the workload controller and/or the control service of the quantity of VMs allocated to a particular server computer, server rack, or co-location. The quantity of VMs can inform the workload controller and/or the control service of computational capacity available on the allocated servers and/or the maximum power draw that could potentially be required of the allocated servers. The workload controller and/or the control service can use the VM allocation information to help anticipate computational and power demands of the co-location and/or datacenter.

In some examples, the process allocation information can inform the workload controller and/or the control service of the particular processes requested or currently being performed on at least some of the server computers of the server rack, co-location, and/or datacenter. In some embodiments, the workload controller and/or the control service includes a process inventory to monitor the processes, as well as the power consumption and computational demands thereof. For example, the workload controller and/or the control service may determine that a first process allocated to a first server computer within the co-location has a first power consumption associated with the first process, and the workload controller and/or the control service may determine that a second process allocated to a second server computer within the co-location has a second power consumption associated with the second process. The workload controller and/or the control service may determine a total current or expected power consumption of the allocated processes based at least partially on the process inventory.

In some embodiments, the process allocation and/or process inventory has a process priority list that informs the workload controller and/or the control service of the relative importance of the processes currently executed or queued in the co-location. For example, a first process allocated to a first server computer may have a higher priority than a second process allocated to a second server computer, and the workload controller may power cap or throttle the second server computer to prioritize the performance of the first process of the first server computer.

In some examples, the process migration status can inform the workload controller and/or the control service of the availability of computational resources for migration of a process between server computers and/or between co-locations. In some examples, the process migration status can inform the workload controller and/or the control service of the initiation and/or completion of a process migration to allow the workload controller and/or the control service to track availability of computational resources.

In some embodiments, the utilization patterns can inform the workload controller and/or the control service of the current or predicted future state of the workload on the co-location based at least partially on historical data and trends of resource utilization. For example, the utilization pattern may include process allocation, power draw, and/or computational load that is based at least partially on time of day, day of the week, day of the year, or correlation to other events, such as weather, holidays, or periodic events. In some embodiments, the workload controller and/or the control service may determine a trend or predicted future state of the workload based on the utilization patterns and pre-emptively change or adjust workload or power supply to at least partially compensate for the trend or predicted future state of the workload.

In some embodiments, the control service and/or energy controller obtains infrastructure parameters. For example, the energy controller may obtain or store the infrastructure parameters and the control service may obtain the infrastructure parameters from the energy controller. The infrastructure parameters include information related to the performance, history, or requirements of the hardware of the co-location, and/or datacenter. In some embodiments, the infrastructure parameters may include battery state of charge, UPS state of charge, battery/UPS degradation (e.g., degradation counters), component temperatures, server computer power draws, maintenance schedule, and other measurements or properties of the energy source(s) and sink(s) within the co-location and/or datacenter.

In some embodiments, the battery state of charge or UPS state of charge includes a percentage state of charge of a long-term battery and/or a UPS, a nominal voltage of a long-term battery and/or a UPS, or a nominal state of charge (e.g., a kilowatt-hour measurement) of a long-term battery and/or a UPS. The battery state of charge or UPS state of charge may inform the control service and/or energy controller of the duration of time that the battery/UPS may provide power or additional power to the server computers in the event of a utility failure or other event.

In some embodiments, the generator capacity allows the control service and/or energy controller to know how much peak power a generator can provide, how long the generator can provide the power, and the total power the generator can provide. In some embodiments, the infrastructure parameter further includes a startup time for the generator, which may inform the control service and/or energy controller of a delay in starting the generator before the generator can begin providing power to the co-location and/or datacenter.

In some embodiments, the battery/UPS degradation includes a total battery aging parameter of the battery and/or UPS, quantity of charge/discharges cycles of the battery and/or UPS, or depth of charge available. For example, a battery may have a limited quantity of charge cycles based on the depth of charge/discharge. A cost is associated with each discharge and charge cycle of the battery. In some embodiments, the age of the battery affects the capacity of the battery, limiting the amount of power an older battery can provide to the co-location relative to a newer battery. In some embodiments, the energy controller monitors the age of the battery (in time, cycles, or capacity) and provides the age to the control service. In some embodiments, the control service monitors the age of the battery based at least partially on information provided by the energy controller.

The energy controller and/or control service, in some embodiments, monitors component temperatures, as elevated temperatures can affect the efficient and/or operational lifetime of the batteries, UPS, or generators in data communication with the energy controller and/or control service.

In some embodiments, the infrastructure parameters include a maintenance schedule of one or more components of the co-location and/or datacenter. For example, some components may be unavailable due to planned maintenance. In other examples, a planned maintenance may require additional power provided by a battery, fuel cell, other long-term energy storage, UPS, or generator, and the energy controller and/or control service may prepare the battery, UPS, or generator in advance to provide the required capacity for the additional power.

The control service obtains utility telemetry, in some embodiments, from a substation, a utility line, or other communication with the utility grid. Utility telemetry may include frequency of the power provided by the utility to and/or through the substation, a carbon intensity of the power provided by the utility to and/or through the substation, and power demand and response of the utility grid. The frequency of the power provided by the utility may vary with utility grid stability, supply and demand. In the electric utility grid, operators attempt to maintain utility grid balance and reliability and keep its frequency within defined limits. Deviation from the nominal frequency, i.e., 50 Hz or 60 Hz, results from a mismatch between supply and demand (a phenomenon that becomes exacerbated by a greater penetration of variable renewable energy sources, which are also associated with carbon intensity of the provided power). A control service according to the present disclosure, in some embodiments, can help operators regulate the utility grid frequency by lowering or increasing a power draw of the co-location and/or datacenter. Frequency regulation may require fast-response energy storage, generators, or fast workload management.

Additionally, some embodiments of a control service according to the present disclosure can provide or assist in providing frequency containment. In some examples, frequency containment reserves, such as those provided by the long-term energy storage, UPS, or generator in communication with the energy controller, can provide a primary response to sudden frequency variations, typically low frequency, caused by a contingency event in the utility grid or sudden drop of renewable energy sources. As the system inertia reduces in the areas with high penetration of renewable energy, even faster reacting reserves (such as batteries relative to generators) may be used to at least partially compensate for low inertia situations. In some embodiments, fast-response battery energy storage in datacenters with limited energy storage duration can provide frequency containment in response to the obtained utility telemetry.

In some embodiments, the obtained utility telemetry includes carbon intensity related to the source and deliver of the power provide by the utility grid. In some embodiments, the control service selectively charges or discharges a battery or engages a generator based on the reducing carbon impact of the co-location and/or datacenter.

In some embodiments, the method further includes comparing the at least one workload status to the at least one utility telemetry and determining a workload demand based at least partially on a difference between the at least one workload status and the at least one utility telemetry. Comparing the at least one workload status and the at least one utility telemetry allows the control service to determine a difference between the power provided by the utility grid and the power required by the current or predicted future state of the workload. For example, a workload status and utility telemetry may indicate a positive workload demand that requires the deployment of one or more of the infrastructure power sources, such as the long-term battery, UPS, or generator, to at least partially compensate for the positive workload demand. In some embodiments, a workload status and utility telemetry may indicate a negative workload demand that provides an opportunity to charge the long-term battery or to overclock processing resources in the co-location and/or datacenter.

In some embodiments, the method further includes changing the at least one infrastructure parameter based at least partially on the workload demand and the at least one infrastructure parameter. For example, changing the at least one infrastructure parameter may include discharging a long-term energy storage. In some examples, changing the at least one infrastructure parameter may include charging a long-term battery. In some examples, changing the at least one infrastructure parameter may include discharging a UPS. In some examples, changing the at least one infrastructure parameter may include engaging a generator. In some embodiments, changing the at least one infrastructure parameter supplements the power received from the utility grid based on the workload demand. In some embodiments, changing the at least one infrastructure parameter supplements the power received from the utility grid based on the workload demand without exporting power from the datacenter (i.e., from the long-term energy storage and/or generation) to the utility grid.

The workload status, the infrastructure parameter, and the utility telemetries may be inputs to an ML model to determine the outputs provided to the controllers by the control service. In other embodiments, the workload status, the infrastructure parameter, and the utility telemetries may be inputs into one or more of heuristics, mathematical models, and algorithms to determine the outputs provided to the controllers by the control service.

As used herein, a “machine learning model” refers to a computer algorithm or model (e.g., a classification model, a regression model, a language model, an object detection model) that can be tuned (e.g., trained) based on training input to approximate unknown functions. For example, a machine learning model may refer to a neural network or other machine learning algorithm or architecture that learns and approximates complex functions and generate outputs based on a plurality of inputs provided to the machine learning model. In some embodiments, a machine learning system, model, or neural network described herein is an artificial neural network. In some embodiments, a machine learning system, model, or neural network described herein is a convolutional neural network. In some embodiments, a machine learning system, model, or neural network described herein is a recurrent neural network. In at least one embodiment, a machine learning system, model, or neural network described herein is a Bayes classifier. As used herein, a “machine learning system” may refer to one or multiple machine learning models that cooperatively generate one or more outputs based on corresponding inputs. For example, a machine learning system may refer to any system architecture having multiple discrete machine learning components that consider different kinds of information or inputs.

As used herein, an “instance” refers to an input object that may be provided as an input to a machine learning system to use in generating an output, such as utility telemetry, workload status, and infrastructure parameters. For example, an instance may refer to any event in which the utility telemetry changes in a manner that affects the frequency of the provided power from the utility grid. For example, low-frequency event may be related to afternoon or evening, in regions with warmer weather, corresponding to an increased demand in the utility grid. In some embodiments, a low-frequency event may be at least partially compensated for with power capping or workload migration, while in other instances, a low-frequency event when workload is high or process priority is high may be at least partially compensated for with additional infrastructure power sources.

In some embodiments, the machine learning system has a plurality of layers with an input layer configured to receive at least one input dataset or input instance and an output layer, with a plurality of additional or hidden layers therebetween. The training datasets can be input into the machine learning system to train the machine learning system and identify individual and combinations of labels or attributes of the training instances that allow the co-location and/or datacenter to participate in grid services. In some embodiments, the inputs include utility telemetry, workload status, infrastructure parameters, or combinations thereof.

In some embodiments, the machine learning system can receive multiple training datasets concurrently and learn from the different training datasets simultaneously. For example, a training dataset of utility grid utility telemetry changes includes different information and/or labels than a training dataset including changes in workload status.

In some embodiments, the machine learning system includes a plurality of machine learning models that operate together. Each of the machine learning models has a plurality of hidden layers between the input layer and the output layer. The hidden layers have a plurality of nodes, where each of the nodes operates on the received inputs from the previous layer. In a specific example, a first hidden layer has a plurality of nodes and each of the nodes performs an operation on each instance from the input layer. Each node of the first hidden layer provides a new input into each node of the second hidden layer, which, in turn, performs a new operation on each of those inputs. The nodes of the second hidden layer then passes outputs, such as identified clusters, to the output layer.

In some embodiments, each of the nodes has a linear function and an activation function. The linear function may attempt to optimize or approximate a solution with a line of best fit, such as reduced power cost or reduced carbon intensity. The activation function operates as a test to check the validity of the linear function. In some embodiments, the activation function produces a binary output that determines whether the output of the linear function is passed to the next layer of the machine learning model. In this way, the machine learning system can limit and/or prevent the propagation of poor fits to the data and/or non-convergent solutions.

The machine learning model includes an input layer that receives at least one training dataset. In some embodiments, at least one machine learning model uses supervised training. Supervised training allows the input of a plurality of utility grid or workload events with known responses from the energy controller and/or workload controller and allows the machine learning system of the control service to develop correlations between the inputs and the responses to learn risk factors and combinations thereof. In some embodiments, at least one machine learning model uses unsupervised training. Unsupervised training can be used to draw inferences and find patterns or associations from the training dataset(s) without known incidents. In some embodiments, unsupervised learning can identify clusters of similar labels or characteristics for a variety of training instances and allow the machine learning system to extrapolate the safety and/or risk factors of instances with similar characteristics.

In some embodiments, semi-supervised learning can combine benefits from supervised learning and unsupervised learning. As described herein, the machine learning system can identify associated labels or characteristic between instances, which may allow a training dataset with known incidents and a second training dataset including more general input information to be fused. Unsupervised training can allow the machine learning system to cluster the instances from the second training dataset without known incidents and associate the clusters with known incidents from the first training dataset.

In some embodiments, offline training of the ML model may include a simulated environment with a datacenter simulator that receives inputs from an IT emulator and a simulated datacenter power infrastructure. The simulated environment outputs a state to a reinforcement learning (RL) agent with a reward (positive or negative reward) associated with the state of the datacenter simulator. The RL agent can create a recurrent loop that provides further inputs the simulated environment to refine the responses and/or outputs of the simulated environment over time.

In some embodiments, the RL agent can provide information to an online ML model that receives live inputs including utility telemetry, workload status, and infrastructure parameters. The RL agent and simulated environment may allow the ML model to be pretrained and/or continually trained offline with additional scenarios, which are then fused with the live inputs at the ML model. A simulated environment can allow for more rapid training of the ML model without the datacenter and/or co-location experiencing the adverse grid or infrastructure conditions simulated in the simulated environment.

In some embodiments, a method of power management in a datacenter includes making changes to both the workload of a co-location and to the power infrastructure of the co-location. The control service may communicate with the energy controller and the workload controller to provide both short-term (e.g., fast response) and long-term grid services and workload balancing. For example, the control service may communicate with the infrastructure power sources (e.g., battery, UPS, generator) to provide rapid responses to a change in utility telemetry or workload status, while the control service also communicates with the workload controller to migrate workload to a second co-location and/or power cap the first co-location to balance the workload demand between available power and cost or carbon intensity of the available power.

In some embodiments, the method includes, at the control service, obtaining at least one workload status of at least one server rack, obtaining at least one infrastructure parameter, and obtaining at least one utility telemetry. In some embodiments, the control service obtains at least a portion of the workload status from the workload controller. In some embodiments, the control service obtains at least a portion of the workload status from one or more server computers. In some embodiments, the controller service obtains at least a portion of the workload status from a rack manager of a server rack in the co-location.

The method further includes, in some embodiments, inputting the at least one utility telemetry, the at least one infrastructure parameter, and the at least one workload status into an ML model, such as described herein, to determine at least one change to each of the at least one infrastructure parameter and the at least one workload status. Based on the output of the ML model, which may be pretrained as described herein, the method includes changing the at least one infrastructure parameter and the at least one workload status.

In some examples, the control service may change at least one infrastructure parameter to charge an infrastructure power source from the utility grid based at least partially on a utility telemetry. In some embodiments, the control service may change at least infrastructure parameter to charge an infrastructure power source from the utility grid based at least partially on a workload status.

For example, a positive workload demand may arise from an infrastructure failure or partial infrastructure failure. In some embodiments, the control service and/or a workload controller may adjust the workload and/or processes of the server computers based on a change in infrastructure parameters. In at least one example, the change in infrastructure parameters may be related to a limited availability of infrastructure power to supply to the server computers. In such an example, the control service and/or workload controller may migrate workload to another co-location to reduce the workload demand. In some examples, the control service and/or workload controller may power cap or throttle the server computers to reduce the workload demand.

The present disclosure relates to systems and methods for power management in a datacenter according to at least the examples provided in the sections below:
[A1] In some embodiments, a method of power management in a datacenter includes obtaining at least one workload status of at least one server rack, obtaining at least one infrastructure parameter, obtaining at least one utility telemetry, and comparing the at least one workload status to the at least one utility telemetry. The method further includes determining a workload demand based at least partially on a difference between the at least one workload status and the at least one utility telemetry and changing the at least one infrastructure parameter based on the workload demand and the at least one infrastructure parameter.
[A2] In some embodiments, the at least one workload status of [A1] includes a power draw of the at least one server rack.
[A3] In some embodiments, the at least one workload status of [A1] or [A2] includes a virtual machine (VM) allocation to the at least one server rack.
[A4] In some embodiments, the at least one workload status of any of [A1] through [A3] includes a predicted future state of the at least one workload status.
[A5] In some embodiments, comparing the at least one workload status to the at least one utility telemetry of any of [A1] through [A4] includes inputting the at least one workload status and the at least one utility telemetry into an input layer of a machine learning (ML) model, and wherein the workload demand is an output of the ML model.
[A6] In some embodiments, the at least one infrastructure parameter of any of [A1] through [A5] includes a generator capacity.
[A7] In some embodiments, the at least one infrastructure parameter of any of [A1] through [A6] includes a battery state of charge.
[A8] In some embodiments, the at least one infrastructure parameter of any of [A1] through [A7] includes a battery aging parameter.
[A9] In some embodiments, the at least one utility telemetry of any of [A1] through [A8] includes a frequency.
[A10] In some embodiments, the at least one utility telemetry of any of [A1] through [A9] includes a demand.
[A11] In some embodiments, the at least one utility telemetry of any of [A1] through [A10] includes a carbon intensity.
[A12] In some embodiments, changing at least one infrastructure parameter of any of [A1] through [A11] includes communicating with a workload controller to change a workload of the at least one server rack and reduce power draw of the at least one server rack.
[A13] In some embodiments, changing at least one infrastructure parameter of any of [A1] through [A12] includes communicating with an energy controller to change a power supply to the at least one server rack
[A14] In some embodiments, changing at least one infrastructure parameter of any of [A1] through [A11] includes changing a power supply to the at least one server rack and changing a workload of the at least one server rack.
[B1] In some embodiments, a system for controlling power supply in a datacenter includes a control service, an energy controller in data communication with the control service, and a workload controller in data communication with the control service. The control service is configured to obtain at least one workload status of at least one server rack, obtain at least one infrastructure parameter, obtain at least one utility telemetry, and compare the at least one workload status to the at least one utility telemetry. The control service is further configured to determine a workload demand based at least partially on a difference between the at least one workload status and the at least one utility telemetry and change the at least one infrastructure parameter based on the workload demand and the at least one infrastructure parameter.
[B2] In some embodiments, the system of [B1] further includes at least one battery in data communication with the energy controller.
[B3] In some embodiments, the system of [B1] or [B2] further includes at least one generation in data communication with the energy controller.
[B4] In some embodiments, the energy controller of any of [B1] through [B3] is a first energy controller associated with a first co-location, and the workload controller is a first workload controller associated with the first co-location. The system further includes a second energy controller associated with a second co-location, wherein the control service is in data communication with the second energy controller and a second workload controller associated with the second co-location, wherein the control service is in data communication with the second workload controller.
[C1] In some embodiments, a method of power management in a datacenter includes obtaining at least one workload status of at least one server rack, obtaining at least one infrastructure parameter, obtaining at least one utility telemetry, and inputting the at least one utility telemetry, at least one workload status, and the at least one infrastructure parameter into an ML model. The method further includes changing the at least one infrastructure parameter based on the at least one utility telemetry, at least one workload status, and the at least one infrastructure parameter and changing the at least one workload status based on the at least one utility telemetry, at least one workload status, and the at least one infrastructure parameter.
[C2] In some embodiments, the ML model of [C1] is pretrained with an offline simulated environment.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the scope of the present disclosure, and that various changes, substitutions, and alterations may be made to embodiments disclosed herein without departing from the scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

It should be understood that any directions or reference frames in the preceding description are merely relative directions or movements. For example, any references to “front” and “back” or “top” and “bottom” or “left” and “right” are merely descriptive of the relative position or movement of the related elements.

The present disclosure may be embodied in other specific forms without departing from its characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method of power management in a datacenter, the method comprising:
at a control service:
obtaining at least one workload status of at least one server rack;
obtaining at least one infrastructure parameter;
obtaining at least one utility telemetry;
comparing the at least one workload status to the at least one utility telemetry;
determining a workload demand based at least partially on a difference between the at least one workload status and the at least one utility telemetry; and
changing the at least one infrastructure parameter based on the workload demand and the at least one infrastructure parameter.

2. The method of claim 1, wherein the at least one workload status includes a power draw of the at least one server rack.

3. The method of claim 1, wherein the at least one workload status includes a virtual machine (VM) allocation to the at least one server rack.

4. The method of claim 1, wherein the at least one workload status includes a predicted future state of the at least one workload status.

5. The method of claim 1, wherein comparing the at least one workload status to the at least one utility telemetry includes inputting the at least one workload status and the at least one utility telemetry into an input layer of a machine learning (ML) model, and wherein the workload demand is an output of the ML model.

6. The method of claim 1, wherein the at least one infrastructure parameter includes a generator capacity.

7. The method of claim 1, wherein the at least one infrastructure parameter includes a battery state of charge.

8. The method of claim 1, wherein the at least one infrastructure parameter includes a battery aging parameter.

9. The method of claim 1, wherein the at least one utility telemetry includes a frequency.

10. The method of claim 1, wherein the at least one utility telemetry includes a demand.

11. The method of claim 1, wherein the at least one utility telemetry includes carbon intensity.

12. The method of claim 1, wherein changing at least one infrastructure parameter includes communicating with a workload controller to change a workload of the at least one server rack and reduce power draw of the at least one server rack.

13. The method of claim 1, wherein changing at least one infrastructure parameter includes communicating with an energy controller to change a power supply to the at least one server rack.

14. The method of claim 1, wherein changing at least one infrastructure parameter includes changing a power supply to the at least one server rack and changing a workload of the at least one server rack.

15. A system for controlling power supply, the system comprising:
a control service;
an energy controller in data communication with the control service; and
a workload controller in data communication with the control service,
wherein the control service is configured to:
obtain at least one workload status of at least one server rack;
obtain at least one infrastructure parameter;
obtain at least one utility telemetry associated with a power utility;
compare the at least one workload status to the at least one utility telemetry;
determine a workload demand based at least partially on a difference between the at least one workload status and the at least one utility telemetry; and
change the at least one infrastructure parameter based on the workload demand and the at least one infrastructure parameter without exporting power to the power utility.

16. The system of claim 15, further comprising at least one long-term energy storage in data communication with the energy controller.

17. The system of claim 15, further comprising at least one generator in data communication with the energy controller.

18. The system of claim 15, wherein the energy controller is a first energy controller associated with a first co-location, and the workload controller is a first workload controller associated with the first co-location, and further comprising:
a second energy controller associated with a second co-location, wherein the control service is in data communication with the second energy controller; and
a second workload controller associated with the second co-location, wherein the control service is in data communication with the second workload controller.

19. A method of power management, the method comprising:
at a control service:
obtaining at least one workload status of at least one server rack;
obtaining at least one infrastructure parameter;
obtaining at least one utility telemetry;
inputting the at least one utility telemetry, at least one workload status, and the at least one infrastructure parameter into an ML model;
changing the at least one infrastructure parameter based on the at least one utility telemetry, at least one workload status, and the at least one infrastructure parameter; and
changing the at least one workload status based on the at least one utility telemetry, at least one workload status, and the at least one infrastructure parameter.

20. The method of claim 19, wherein the ML model is pretrained with an offline simulated environment.
